(19) United States
(12) Patent Application Publication
(10) Pub. No.: US 2013/0072252 A1
(43) Pub. Date: Mar. 21, 2013

(54) WIRELESS DEVICE AND WIRELESS CONNECTION METHOD THEREOF

(71) Applicants: Hsi-Kun CHEN, Taoyuan City (TW); Hsiang-Tai HUANG, Taoyuan City (TW); Chih-Kuang WANG, Taoyuan City (TW)

(72) Inventors: Hsi-Kun CHEN, Taoyuan City (TW); Hsiang-Tai HUANG, Taoyuan City (TW); Chih-Kuang WANG, Taoyuan City (TW)

(73) Assignee: HTC CORPORATION, Taoyuan City (TW)

(21) Appl. No.: 13/237,321

(22) Filed: Sep. 20, 2011

(51) Int. Cl. H04W 88/02

(52) U.S. Cl. 455/550.1

(57) ABSTRACT

A wireless device and a wireless connection method thereof are provided. The wireless device comprises a storage, a connection interface and a wireless transceiver. The storage is configured to store a wireless connection configuration. The connection interface is configured to transmit the wireless connection configuration to an electrical device via a transmission line or a memory card. The wireless transceiver is configured to automatically build a wireless connection with the electrical device after the electrical device has received the wireless connection configuration and executed a wireless connection procedure according to the wireless connection configuration.

### CROSS-REFERENCES TO RELATED APPLICATIONS

Not applicable.

### BACKGROUND OF THE INVENTION

1. Field of the Invention

The subject invention relates to a wireless device and a wireless connection method thereof. More particularly, the subject invention relates to a wireless device and a wireless connection method thereof, which can automatically build a wireless connection with an electrical device.

2. Descriptions of the Related Art

With rapid development of wireless communications, demands on wireless communications also become increasingly higher. As people's demands on the wireless communication become increasingly higher, wireless devices (e.g., mobile phones, notebook computers, tablet personal computers, and the same) have gradually become indispensable to people's life. In order to meet the demands, wireless device manufacturers all try to design the wireless devices to be more humanized or more adapted for people's needs.

One of the people's needs on the wireless devices is providing a simpler wireless connection procedure so that an electrical device can communicate with the wireless devices without a lot of complicated wireless connection steps. For a conventional wireless device, it can provide a wireless connection service for an electrical device via various wireless mechanisms (e.g. Bluetooth, WLAN, etc.). Unfortunately, the conventional wireless device makes a problem that the electrical device has to execute a lot of wireless connection steps before the wireless connection was built. Thus, the user of the electrical device has also to finish a lot of operations in response to the wireless connection steps.

In general, the user at least needs to execute the following operations on the electrical device, including enabling the electrical device to search the wireless device and execute a connection pairing procedure or a connection authentication procedure. Because the above operations for some users having no associated technical ground are really complicated and time-consuming, these users possibly fail to execute the operations so that the electrical device can not get the wireless connection with the wireless device. Consequently, the conventional wireless device makes a lot of complicated wireless connection steps on the electrical device so that the electrical device can not easily get the wireless connection with the wireless device.

In view of this, since no useful resolution to deal with the problem up to now, an urgent need exists in the art to effectively overcome the shortcomings of conventional wireless connection procedure.

### SUMMARY OF THE INVENTION

The objective of the subject invention is to provide a wireless device and a wireless connection method thereof, which can effectively solve the problems of the prior art caused due to a lot of complicated and technical wireless connection operations.

To achieve the aforesaid objective, the subject invention provides a wireless device. The wireless device comprises a storage, a connection interface and a wireless transceiver. The storage is configured to store a wireless connection configuration. The connection interface is configured to transmit the wireless connection configuration to an electrical device via a transmission line or a memory card. The wireless transceiver is configured to automatically build a wireless connection with the electrical device after the electrical device has received the wireless connection configuration and executed a wireless connection procedure according to the wireless connection configuration.

To achieve the aforesaid objective, the subject invention further provides a wireless connection method for use in a wireless device. The wireless device comprises a storage, a connection interface and a wireless transceiver. The wireless connection method comprises the following steps of: (a) enabling the storage to store a wireless connection configuration; (b) enabling the connection interface to transmit the wireless connection configuration to an electrical device via a transmission line or a memory card; and (c) enabling the wireless transceiver to automatically build a wireless connection with the electrical device after the electrical device has received the wireless connection configuration and executed a wireless connection procedure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of wireless device 1 according to the subject invention;

FIG. 2 is a schematic view of wireless device 3 according to the subject invention;

FIG. 3 is a flowchart of the third embodiment of the subject invention; and

FIG. 4 is a flowchart of the fourth embodiment of the subject invention.

### DESCRIPTION OF THE PREFERRED EMBODIMENT

In the following description, the subject invention will be explained with reference to embodiments thereof. However, these embodiments are not intended to limit the subject invention to any specific environment, applications or particular implementations described in these embodiments. Therefore, description of these embodiments is only for purpose of illustration rather than to limit the subject invention. It should be appreciated that, in the following embodiments and the attached drawings, elements not directly related to the subject invention are omitted from depiction; and dimensional relationships among individual elements in the attached drawings are illustrated only for ease of understanding, but not to limit the actual scale.

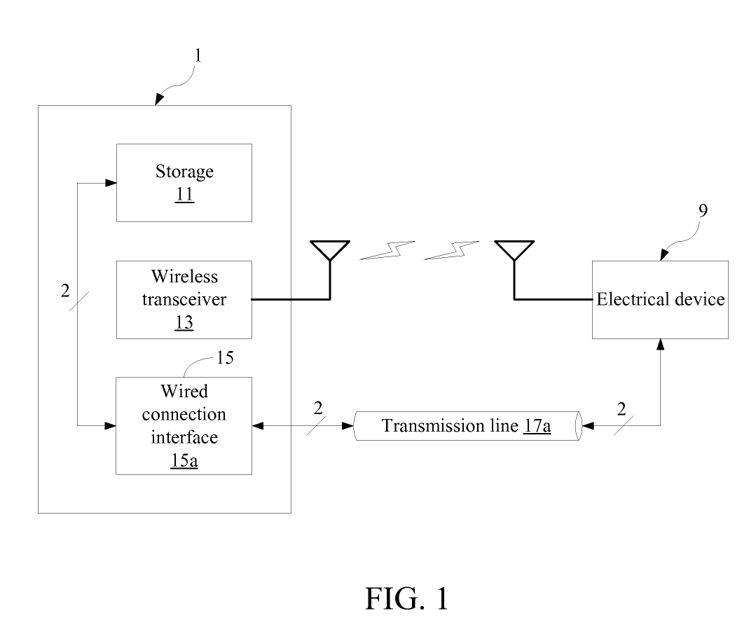

A first embodiment of the subject invention is shown in FIG. 1, which is a schematic view of a wireless device 1. As shown in FIG. 1, wireless device 1 comprises a storage 11, a connection interface 13 and a wireless transceiver 15. The storage 11 is configured to store a wireless connection configuration 2, which may comprise the Service Set Identifier (SSID), a wireless connection password and the Media Access Control (MAC) address of the wireless device 1. It should be appreciated that the wireless connection configuration 2 may also comprise other information related wireless connections and is not limited in this embodiment. Furthermore, how the storage 11 stores the wireless connection configuration 2 to people skilled in the art is readily comprehended, and thus will not be further described herein.

As shown in FIG. 1, the connection interface 15 in this embodiment is a wired connection interface 15a and configured to transmit the wireless connection configuration 2 to an electrical device 9 via a transmission line 17a. Specifically, the wired connection interface 15a can build a wired connection between the wireless device 1 and the electrical device 9 via the transmission line 17a so as to transmit the wireless connection configuration 2 to the electrical device 9. It should be emphasized that the aforesaid operations of the connection interface 15a and the transmission line 17a are only for initial setting procedure in the whole wireless connection procedure. Furthermore, once the electrical device 9 has known the wireless connection configuration 2, the aforesaid operations of the connection interface 15a and the transmission line 17a are unnecessary anymore. The wired connection interface 15a and the transmission line 17a may further comply with a Universal Serial Bus (USB) standard or an IEEE 1394 standard, and thus the wired connection interface 15a transmits the wireless connection configuration 2 to the electrical device 9 according to the USB standard or the IEEE 1394 standard. However, the wired connection interface 15a and the transmission line 17a may also comply with other wired connection standards in other embodiments.

The wireless transceiver 15 is configured to automatically build a wireless connection with the electrical device 9 after the electrical device 9 has received the wireless connection configuration 2 and executed a wireless connection procedure according to the wireless connection configuration 2. Specifically, when the electrical device 9 has received the wireless connection configuration 2 via the transmission line 17a, the electrical device 9 will obtain all of the information in connection with building a wireless connection with the wireless device 1 from the wireless connection configuration 2. And then, the electrical device 9 can execute a wireless connection procedure according to the wireless connection configuration 2.

In general, the wireless connection procedure can be automatically processed by the electrical device 9 according to a well-known auto-run technique when the wireless connection configuration 2 has been received by the electrical device 9. For example, the electrical device 9 may be a computer which comprises a corresponding USB interface and an auto-run program module, and the auto-run program module can be one of software, hardware and firmware. Particularly, once the USB interface has detected the wired connection interface 15a via the transmission line 17a and received the wireless connection configuration 2, the auto-run program will be executed to automatically access the wireless connection information from the wireless connection configuration 2 and then to build a wireless connection with the wireless device 1 according to the wireless connection information. It should be appreciated that how the electrical device 9 deals with the wireless connection procedure can be readily comprehended, and thus will not be further described herein.

To further highlight the technical features and the advantages of the subject invention, an exemplary practice of this embodiment will be interpreted hereinafter. It is assumed that the wireless device 1 is a smart phone having an Android operating system, and it acts as a Wi-Fi hotspot role and supports the third generation (3G) modem function which can relay Wi-Fi traffic to 3G networks and versus. Furthermore, the electrical device 9 is assumed as a tablet computer having the Android operating system, and it acts as a Wi-Fi station role and transmits and receives mobile data through the Wi-Fi hotspot (i.e., the wireless device 1).

Firstly, a conventional wireless connection procedure which connects the wireless device 1 with the electrical device 9 will be described. Specifically, the initial setting procedure on the wireless device 1 may comprise the following operations of: (a1) tapping the program button icon on the home screen; (a2) launching Wi-Fi hotspot utility; (a3) setting a wireless connection configuration 2; and (a4) starting Wi-Fi hotspot and waiting for Wi-Fi station's association. It is assumed that the wireless connection configuration 2 comprises the SSID and a wireless connection password of the wireless device 1 herein.

On the other hand, the initial setting procedure on the electrical device 9 may comprise the following operations of: (b1) tapping the menu button icon on the home screen; (b2) tapping the setting button icon; (b3) tapping the wireless & networks item; (b4) checking the Wi-Fi button icon to turn on Wi-Fi function; (b5) waiting for scanning the neighboring access points and adding them to the available access points list; (b6) choosing the SSID of the wireless device 1 from the available access points list if it is available; and (b7) entering the wireless connection password of the wireless device 1.

According to the above descriptions, it is inevitable that the user of the electrical device 9 is necessary to not only execute a lot of operations on the electrical device 9 but also obtain the wireless connection password of the wireless device 1 to get a wireless connection with the wireless device 1. It is clear that the conventional wireless connection procedure for some users having no associated technical ground is really complicated and time-consuming.

In contrast with the conventional wireless connection procedure, since the wireless connection configuration 2 of the wireless device 1 can be transmitted to the electrical device 9 via the wired connection interface 15a and the transmission line 17a, the initial setting procedure on the electrical device 9 can be simplified. Particularly, the electrical device 9 determines whether the wireless connection configuration 2 has been stored therein as it is connected with the wireless device 1 connects via the wired connection interface 15a and the transmission line 17a. If it does, the electrical device 9 will execute an auto-run program to build a wireless connection with the wireless device 1 according to the wireless connection configuration 2. If it does not, the electrical device 9 will store the wireless connection configuration 2 before executing the auto-run program.

Therefore, users of the electrical device 9 is only necessary to execute an operation which connects the wireless device 1 with the electrical device 9 via the wired connection interface 15a and the transmission line 17a to get a wireless connection with the wireless device 1. Thus, the users having no associated technical ground can also readily finish the wireless connection operation on the electrical device 9.

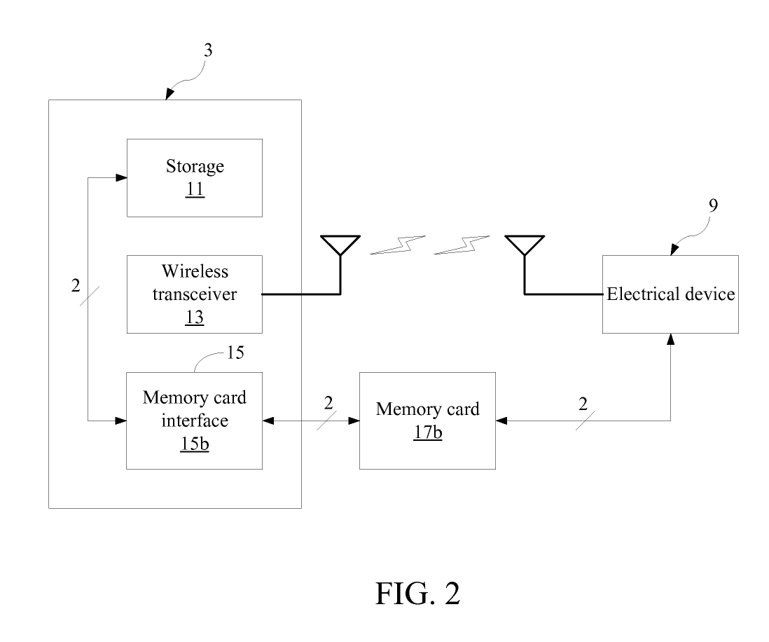

A second embodiment of the subject invention is shown in FIG. 2, which is a schematic view of a wireless device 3. The second embodiment of the subject invention is similar to the first embodiment, and the prime difference between them will be described hereinafter. It should be appreciated that some of the reference numerals and contents of the first embodiment apply also to the second embodiment, wherein identical reference numerals are used to denote the same or similar elements, and descriptions of identical technical contents will be omitted. Furthermore, the detailed descriptions of the omitted portions may be referred to the first embodiment.

As shown in FIG. 2, wireless device 3 comprises a storage 11, a connection interface 13 and a wireless transceiver 15. The storage 11 is configured to store a wireless connection configuration 2. The connection interface 15 in this embodiment is a memory card interface 15b and is configured to transmit the wireless connection configuration 2 to an electrical device 9 via a memory card 17b. Specifically, the memory card interface 15b can store the wireless connection configuration 2 into a memory card 17b when the memory card 17b is plugged into the memory card interface 15b so that the electrical device 9 loads the wireless connection configuration 2 via the memory card 17b and executes a wireless connection procedure according to the wireless connection configuration 2 when the memory card 17b is removed from the memory card interface 15b and plugged into the electrical device 9. It should be emphasized that the aforesaid operations of the memory card interface 15b and the memory card 17b are only for initial setting procedure in the whole wireless connection procedure. Furthermore, once the electrical device 9 has known the aforesaid operations of the memory card interface 15b and the memory card 17b are unnecessary anymore.

The memory card interface 15b and the memory card 17b may comply with a Multimedia Card standard or a Secure Digital Card standard, and thus the memory card interface 15b transmits the wireless connection configuration 2 to the electrical device 9 according to the Multimedia Card standard or the Secure Digital Card standard. However, the memory card interface 15b and the memory card 17b may further comply with other wired connection standards in other embodiment.

The wireless transceiver 15 is configured to automatically build a wireless connection with the electrical device 9 after the electrical device 9 has received the wireless connection configuration 2 and executed a wireless connection procedure according to the wireless connection configuration 2. Specifically, when the electrical device 9 has received the wireless connection configuration 2 via the memory card 17, the electrical device 9 will obtain all of the information related to building a wireless connection with the wireless device 1 from the wireless connection configuration 2. And then, the electrical device 9 can execute a wireless connection procedure according to the wireless connection configuration 2.

It should be appreciated that the second embodiment can also implement all the operations and the functions described in the first embodiment except the aforesaid differences. Furthermore, how the second embodiment implements these operations and functions will be readily appreciated by those of ordinary skill in the art based on the explanation of the first embodiment, and thus will not be further described herein.

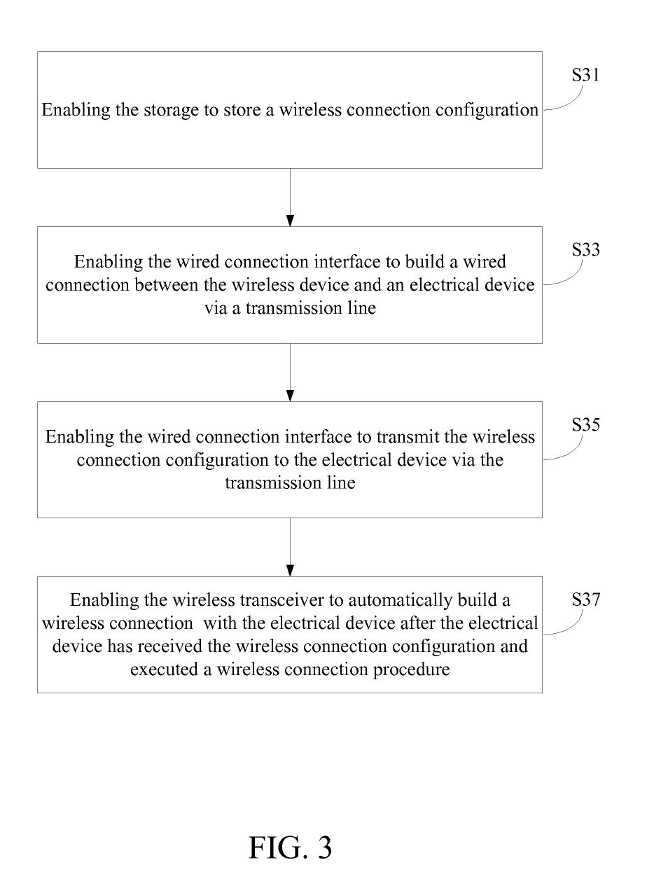

A third embodiment of the subject invention is shown in FIG. 3, which is a flowchart of a wireless connection method for use in a wireless device. In this embodiment, the wireless device can play the role of the wireless device as described in the first embodiment. The wireless device comprises a storage, a wired connection interface and a wireless transceiver.

Referring to FIG. 3, step S31 is executed by the wireless device to enable the storage to store a wireless connection configuration. Then, step S33 is executed by the wireless device to enable the wired connection interface to build a wired connection between the wireless device and an electrical device via a transmission line. Next, step S35 is executed by the wireless device to enable the wired connection interface to transmit the wireless connection configuration to the electrical device via the transmission line. Finally, step S37 is executed by the wireless device to enable the wireless transceiver to automatically build a wireless connection with the electrical device after the electrical device has received the wireless connection configuration and executed a wireless connection procedure.

It should be appreciated that the third embodiment can also implement all the operations and the functions described in the first embodiment except the aforesaid steps. Furthermore, how the third embodiment implements these operations and functions will be readily appreciated by those of ordinary skill in the art based on the explanation of the first embodiment, and thus will not be further described herein.

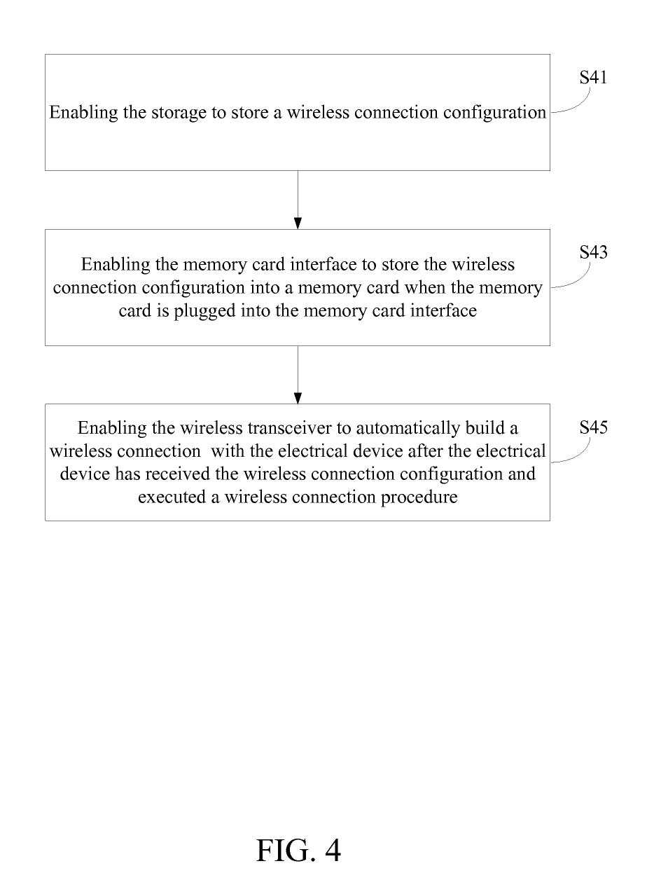

A fourth embodiment of the subject invention is shown in FIG. 4, which is a flowchart of a wireless connection method for use in a wireless device. In this embodiment, the wireless device can play the role of the wireless device as described in the second embodiment. The wireless device comprises a storage, a memory card interface and a wireless transceiver.

Referring to FIG. 4, step S41 is executed by the wireless device to enable the storage to store a wireless connection configuration. Then, step S43 is executed by the wireless device to enable the memory card interface to store the wireless connection configuration into a memory card when the memory card is plugged into the memory card interface so that when the memory card is removed from the memory interface and plugged into the electrical device, the electrical device loads the wireless connection configuration and executes the wireless connection procedure according to the wireless connection configuration. Finally, step S45 is executed by the wireless device to enable the wireless transceiver to automatically build a wireless connection with the electrical device after the electrical device has received the wireless connection configuration and executed the wireless connection procedure.

It should be appreciated that the fourth embodiment can also implement all the operations and the functions described in the second embodiment except the aforesaid steps. Furthermore, how the fourth embodiment implements these operations and functions will be readily appreciated by those of ordinary skill in the art based on the explanation of the second embodiment, and thus will not be further described herein.

According to the above descriptions, the wireless device of the subject invention can transmit a wireless connection configuration to an electrical device so that the conventional wireless connection procedure between the wireless device and the electrical device can be simplified. Thereby, the problems of the prior art caused due to a lot of complicated and technical wireless connection operations can be effectively solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless device, comprising:
a storage, being configured to store a wireless connection configuration;
a connection interface, being configured to transmit the wireless connection configuration to an electrical device via a transmission line or a memory card; and
a wireless transceiver, being configured to automatically build a wireless connection with the electrical device after the electrical device has received the wireless connection configuration and executed a wireless connection procedure according to the wireless connection configuration.

2. The wireless device as claimed in claim 1, wherein the connection interface is a wired connection interface configured to build a wired connection between the wireless device and the electrical device via the transmission line so as to transmit the wireless connection configuration to the electrical device.

3. The wireless device as claimed in claim 2, wherein the wired connection interface and the transmission line comply with one of a Universal Serial Bus (USB) standard and an IEEE 1394 standard.

4. The wireless device as claimed in claim 1, wherein the connection interface is a memory card interface configured to store the wireless connection configuration into a memory card when the memory card is plugged into the memory card interface so that when the memory card is removed from the memory card interface and plugged into the electrical device, the electrical device loads the wireless connection configuration and executes the wireless connection procedure according to the wireless connection configuration.

5. The wireless device as claimed in claim 4, wherein the memory card interface and the memory card comply with one of a Multimedia Card standard and a Secure Digital Card standard.

6. A wireless connection method for use in a wireless device, the wireless device comprising a storage, a connection interface and a wireless transceiver, the wireless connection method comprising the following steps of:
(a) enabling the storage to store a wireless connection configuration;
(b) enabling the connection interface to transmit the wireless connection configuration to an electrical device via a transmission line or a memory card; and
(c) enabling the wireless transceiver to automatically build a wireless connection with the electrical device after the electrical device has received the wireless connection configuration and executed a wireless connection procedure.

7. The wireless connection method as claimed in claim 6, wherein the connection interface is a wired connection interface, the step (b) further comprises the following steps of:
(b1) enabling the wired connection interface to build a wired connection between the wireless device and the electrical device via the transmission line; and
(b2) enabling the wired connection interface to transmit the wireless connection configuration to the electrical device via the transmission line.

8. The wireless connection method as claimed in claim 7, wherein the wired connection interface and the transmission line comply with one of a USB standard and IEEE 1394 standard.

9. The wireless connection method as claimed in claim 6, wherein the connection interface is a memory card interface, the step (b) further comprises the following step of:
(b1) enabling the memory card interface to store the wireless connection configuration into the memory card when the memory card is plugged into the memory card interface so that when the memory card is removed from the memory interface and plugged into the electrical device, the electrical device loads the wireless connection configuration and executes the wireless connection procedure according to the wireless connection configuration.

10. The wireless connection method as claimed in claim 9, wherein the memory card interface and the memory card comply with one of a Multimedia Card standard and a Secure Digital Card standard.
